(19) United States
(12) Patent Application Publication
(10) Pub. No.: US 2008/0170642 A1
(43) Pub. Date: Jul. 17, 2008

(54) Wireless voice communication circuit

(75) Inventors: Kazuhiko Seki, Tokyo (JP); Takashi Taya, Tokyo (JP)

Correspondence Address: JUNICHI MIMURA;OKI AMERICA INC., 1101 14TH STREET, N.W., SUITE 555, WASHINGTON, DC, 20005, US

(73) Assignee: Oki Electric Industry Co., Ltd.

(21) Appl. No.: 11/984,147

(22) Filed: Nov. 14, 2007

(30) Foreign Application Priority Data
Jan. 16, 2007 (JP) 2007-006556

(51) Int. Cl. H04L 27/14; H04L 27/00; H04L 27/22

(52) U.S. Cl. 375/329; 375/316; 375/334

(57) ABSTRACT

A wireless voice communication circuit includes an AD converter generating a first digital variable density signal from voice signal, and a first speed change circuit storing the first signal temporally in a first buffer and reading out it at a burst, a sending frame processing circuit generating a sending frame from the first signal, a modulator modulating and sending a frequency carrier in response to the sending frame, a demodulator demodulating a radio frequency signal received and outputting a receiving frame, a receiving frame processing circuit extracting a second digital variable density signal and outputting it together with a writing timing signal, a second speed change circuit writing the second signal in a second buffer temporally and reading out the signal stored in the second buffer at constant speed.

### CROSS-REFERENCE TO RELATED APPLICATION

This application claims the priority benefit of Japanese Patent Application No. 2007-006556, filed Jan. 16, 2007, the entire disclosure of which is incorporated herein by reference.

### BACKGROUND OF THE INVENTION

1. Field of the Invention

The invention relates to a wireless voice communication circuit used in codeless telephones or intercoms, which sends and receives voice information simultaneously through a wireless communication.

2. Description of the Related Art

There are two major systems for a wireless voice communication circuit, in which the full duplex communication can be performed. One is an analog type and the other is a digital type. Under the full duplex communication in both types, while voice data are sent, the other voice data can be received.

This conventional analog type is disclosed in the reference JP H11-317683. Generally, the analog type wireless voice communication circuit is known as a Frequency Modulation (FM) communication circuit. Under the analog type, a voice signals are superimposed on a control voltage of a Voltage Control Oscillator (VCO) for generating transmit frequency, and amplitude information, which creates a voice signal, is transmitted after transforming it into the frequency shift. At the receiver, the voice signal is demodulated by a wave modulator, which transforms the shift of the frequency into amplitude.

Under the analog type, although it is possible to perform the high quality communication circuit by the relatively simple circuit configuration, there are some problems as described below. First, since the occupied bandwidth is narrow, the output power from a device become restricted at low by the regulation of laws so that the talking range is also restricted at short. In order to perform the full duplex communication, two radio frequencies, each of which is separated enough not to be interfered to each other, are required so that the frequency in use is inefficiency. Moreover, since the main signals are transmitted through the analog circuits, it is required to adjust the variation in temperature among the circuit components. Furthermore, under the analog type, the characteristics of a particular circuit may be varied depending on the devices, even if these devices have the same functions. Further, in order to control the voice signals to be sent and received, the data for controlling the voice signal should be required to be sent and received. Thus, the digital type, which has high affinity with the data communication, is the mainstream in this field.

In the digital type wireless voice communication, a voice signal is transformed into a digital signal having 10-16 bits with 8 kHz by an Analog/Digital Converter ADC, and then, the digital signal is further compressed and encoded by a COder/DECoder CODEC into a Pulse Code Modulation PCM signal having a bit rate of 64 kbps or an Adaptive Differential Pulse Code Modulation ADPCM signal having a bit rate of 32 kbps. After that, the digital modulation, such as Frequency Shift Keying FSK or Phase Shift Keying PSK, is processed to the compressed and encoded digital signal, and processed signal is sent. At a receiver of the signal, the receiving signal is demodulated in the digital signal series by a digital demodulator, and then, the demodulated signal is decoded by the CODEC through an error adjuster for reducing an influence of the bit-error occurred during the wireless transmission. The decoded signal digital voice signal is transformed into an analog signal by a Digital/Analog Converter DAC, and a voice is outputted. A delta sigma ΔΣ modulation done in the ADC is, for example, disclosed in Japanese in the following WEB page.
http://www.okuma.nuee.nagoya-u.ac.jp/˜murahasi/dsm/index.html

Under the digital type, the voice signal, which is transformed into the digital signal, is stored in a buffer temporally, and then, the digital signal in the buffer is transmitted in a double speed so that the transfer time can be shortened. As a result, a spare time can be created. Thus, Time Division Duplex TDD system, in which signal from the intended party is receives during the spare time, can be employed under the digital type. Accordingly, the full duplex communication is performed within the single radio frequency, according to the digital type. Further, in addition to the voice signal, data can be sent and received simultaneously so that the digital type has an advantage for the data communication because of its high affinity.

However, under the digital type, since the digital signal is transmitted with high speed, the frequency bandwidth is wider than that used in the analog type. Thus, when the high speed digital signal is transmitted in situ, since a wide frequency bandwidth is required, the transmission power for satisfying the desired line quality becomes larger and it is easy to become affect by an interfering wave. Further, when the multilevel modulation, such as 64 Quadrature Amplitude Modulation QAM, 128 QAM or 256 QAM, is performed in order to reduce the required radio frequency, the more the bit number of the multilevel modulation is increased, the less the error performance of the receiving signal is deteriorated dramatically. For this reasons, as described above, the technology for reducing the speed of the transmittance by using compressing/encoding of the CODEC is employed.

However, the CODEC makes the scale of the circuit larger and makes the cost higher, and the process delay for decoding the signal may occurs. This delay generates a serious reverberant sound caused by the voice signal, which is returned from the intended party, during the signal transmission. To solve this problem, an echo canceller is employed next to the CODEC, and the reverberant sound is suppressed by the echo canceller. The echo canceller calculates the predicted value from the echo of the voice signal sent to myself while the valid voice signal is not received from the intended party, and removes an echo component included in the receiving signal by deducting the predicted value from the receiving signal. However, as well as the CODEC, the echo canceller also makes the scale of the circuit larger and makes the cost higher.

### SUMMARY OF THE INVENTION

An objective of the invention is to solve the above-described problem and to provide a digital type wireless voice communication circuit, in which the full duplex communication can be performed, without requiring any CODECs or any echo cancellers.

The objective is achieved by a wireless voice communication circuit including an analog-digital converter generating a first digital VARIABLE DENSITY signal whose frequency of the level change is changed in response to the level change speed of a sending audio signal, the first digital VARIABLE DENSITY signal being a continuing binary signal, a first speed change circuit writing the first digital VARIABLE DENSITY signal temporally in a first buffer for compressing in a time-division frame, and reading out the signal stored in the first buffer at a burst in response to a read-out timing signal, a sending frame processing circuit applying the read-out timing signal to the first speed change circuit at sending, and generating a sending frame, which includes the first digital variable density signal read-out from the first speed change circuit, a modulator digital-modulating a frequency carrier applied to the modulator in response to the sending frame, and sending it as a radio frequency signal to an intended party, a demodulator demodulating a radio frequency signal sent from the intended party at receiving, and outputting a receiving frame, a receiving frame processing circuit extracting a second digital variable density signal included in the radio frequency signal sent from the intended party, and outputting it together with a writing timing signal, a second speed change circuit writing the second variable density signal in a second buffer temporally in response to the writing timing signal, and reading out the signal stored in the second buffer at constant speed, and a digital-analog converter generating a receiving voice signal by removing a high frequency component of the second digital variable density signal read-out from the second speed change circuit.

### BRIEF DESCRIPTION OF THE DRAWINGS

The invention will be more particularly described with reference to the accompanying drawings, in which:

FIG. 1 is a circuit diagram of a wireless voice communication circuit, according to the first embodiment;

FIG. 2 is a signal waveform diagram showing an operation of the circuit of FIG. 1; and

FIG. 3 is a circuit diagram of a wireless voice communication circuit, according to the second embodiment.

### DETAILED DESCRIPTION OF THE PREFERRED EMBODIMENTS

The preferred embodiment of the invention is explained together with drawings as follows. In each drawing, the same reference numbers designate the same or similar components.

### The First Embodiment

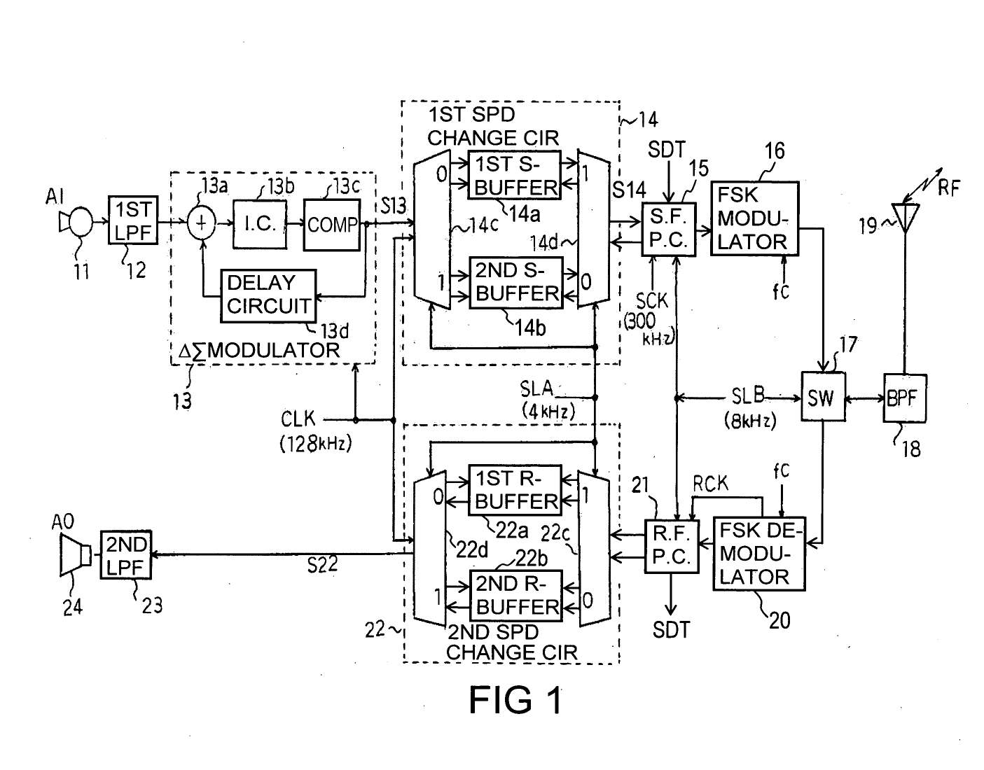

FIG. 1 is a circuit diagram of a wireless voice communication circuit 100, according to the first embodiment of the invention. The wireless voice communication circuit 100 includes-an acoustic input device 11 for transforming an audio input AI to be sent into an electric signal, such as a microphone. The electric signal transformed in the acoustic input device 11 is applied to a first Low Pass Filter (LPF) 12. The first LPF 12 deducts the unnecessary high frequency component to suppress the folding noise caused by the high frequency component. The output of the first LPF 12 is connected to a delta sigma ΔΣ modulator 13.

The ΔΣ modulator 13 generates a pulse signal S13, which is a 1 bit digital variable density signal whose frequency of the level change is changed in response to the level change speed of the input signal. The ΔΣ modulator 13 includes an adder circuit 13a for receiving the input signal from the first LPF 12, an integration circuit 13b for receiving an output signal from the adder circuit 13a, a comparator 13c for receiving an output signal from the integration circuit 13c, and a delay circuit 13d for receiving an output signal from the comparator 13c and for feeding back to adder circuit 13a. The adder circuit 13a deducts a signal delaying the pulse signal S13 from the input signal. The integration circuit 13b integrates the output signal of the adder circuit 13a. The comparator 13c outputs the pulse signal 13S as a result of the comparison between the output signal of the integration circuit 13b and the threshold. The delay circuit 13d delays the pulse signal 13S, and inputs the delayed pulse signal to the adder circuit 13a. The Al modulator 13 receives a clock signal CLK with 128 kHz, and outputs the pulse signal S13 having a bit rate of 128 kbps continuously wherein the higher the speed of the level change of the input signal (the audio input AO) is, the higher the occurrence frequency of the pulse signal Si 3 having the logic level “1” is. The pulse signal S13 is also applied to a first speed change circuit 14 as a next stage.

The first speed change circuit 14 compresses the continuing pulse signal S13 at a constant frequency, and outputs a time-division frame signal S14. The first speed change circuit 14 includes first and second sending buffers 14a and 14b and first and second selectors 14c and 14d for switching the first and the second sending buffers 14a and 14b back and forth in response to a selection signal SLA with 4 kHz. The first selector 14c transfers the pulse signal S13 and the clock signal CLK to the first sending buffer 14a in response to the selection signal SLA having the logic level “0”, and the pulse signal S13 as voice data for sending is stored sequentially in the first sending buffer 14a. On the other hand, the first selector 14c transfers the pulse signal S13 and the clock signal CLK to the second sending buffer 14b in response to the selection signal SLA having the logic level “1. Since the pulse signal 13S is stored in the first or the second buffer 14a or 14c in 128 kbps for 125 μs, the capacity of the pulse signal S13 in the first or the second buffer 14a or 14b is 16 bits.

The second selector 14d outputs a timing signal with 300 kHz for the read-out to the second buffer 14b in response to the selection signal SLA having the logic level “0”, the voice data stored in the second buffer 14b are read out sequentially in response to the timing signal. On the other hand, the second selector 14d outputs a timing signal with 300 kHz for the read-out to the first buffer 14a in response to the selection signal SLA having the logic level “1”, the voice data stored in the first buffer 14a are read out sequentially in response to the timing signal. The read-out voice data by the second selector 14b are applied as the signal S14 to a sending frame processing circuit 15 as the next stage. The timing signal for the read-out is applied from the sending frame processing circuit 15.

The sending frame processing circuit 15 generates a time division frame (sending frame) from the signal 14S and sending data SDT for sending, which are applied from an unillustrated control circuit, in response to a sending clock signal SCK with 300 kHz. The output of the sending frame processing circuit 15 is connected to a Frequency Shift Keying FSK modulator 16 as a next stage. In accordance with the sending frame outputted from the sending frame processing circuit 15, the FSK modulator 16 FSK-modulates a frequency carrier FC, and then outputs it to a switch SW 17 for switching functions of sending and receiving.

The switch 17 switches its functions of sending and receiving in response to a selection signal SLB with 8 kHz. The output signal from the FSK modulator 16 is transmitted to a Band Pass Filter BPF 18 through the switch 17 when the level of the selection signal SLB is “0”. The BPS 18 prevents an unnecessary radio wave from radiating or receiving in order to restrict the radio frequency bandwidth in use, and connects to an antenna 19. On the other hand, when the level of the selection signal SLB is “1”, a high radio frequency RF signal, which is sent from the intended party, received at the antenna 19 and passed through the BPF 17 is applied to an FSK demodulator 20 through the switch 17.

The FSK demodulator 20 demodulates the FSK modulated frequency carrier FC, which is applied through the switch 17, and regenerates a receiving clock signal RCK and a time-division frame (receiving frame). The output of the FSK demodulator 20 is connected to a receiving frame processing circuit 21. Since the FSK demodulator 20 receives the FSK modulated frequency carrier FC from the FSK modulator 16 or the intended party though the antenna 19 and the BPF 18, the receiving frame processing circuit 21 needs to analyze the receiving frame from the FSK demodulator 20 in order to identify whether the frequency carrier FC is either the voice data sent from the intended party or the sending data from its own circuit. When the receiving frame processing circuit 21 detects the sending data, the sending data are sent to the control circuit as a receiving data RDT. On the other hand, when the receiving frame processing circuit 21 detects the voice signal from the intended party, the voice signal is sent to a second speed change circuit 22 together with a timing signal having 300 kHz for the writing.

The second speed change circuit 22 generates a continuing pulse signal S22 by expanding the compressed time-division frame. The second speed change circuit 22 includes first and second receiving buffers 22a and 22b and third and fourth selectors 22c and 22d for switching the first and the second receiving buffers 22a and 22b back and forth in response to the selection signal SLA. The third selector 22c transfers the receiving voice data and the timing signal to the first receiving buffer 22a in response to the selection signal SLA having the logic level “1”, and the receiving voice data are written at a burst in the first receiving buffer 22a. The third selector 22c transfers the receiving voice data and the timing signal to the second receiving buffer 22b in response to the selection signal SLA having the logic level “0”.

The fourth selector 22d sends the clock signal CLK to the first receiving buffer 22a in response to the selection signal SLA having the logic level “0”, and the voice data stored in the first receiving buffer 22a are read out continuously in accordance with the clock signal CLK. On the other hand, the fourth selector 22d sends the clock signal CLK to the second receiving buffer 22b in response to the selection signal SLA having the logic level “1”, and the voice data stored in the second receiving buffer 22b are read out in accordance with the clock signal CLK. The voice data read out by the fourth selector 22d are applied to a second LPF 23 as a continuing pulse signal S22.

The second LPF 23 regenerates the receiving voice signal by deducting the unnecessary high frequency component of the continuing pulse signal S22. The output of the second LPF 23 is connected to an acoustic output device 24 such as a speaker. The acoustic output device 24 transforms the electric signal from the second LPF 23 into an audio output AO.

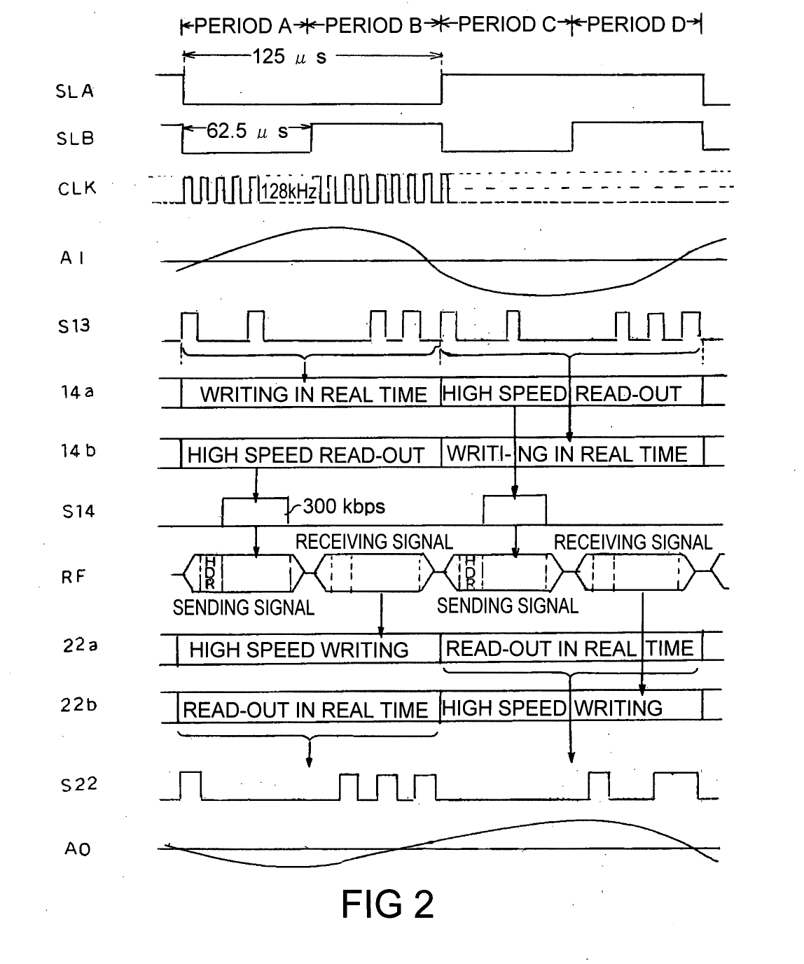

FIG. 2 is a signal waveform diagram showing an operation of the circuit of FIG. 1. The operation of the circuit of FIG. 1 is explained below with reference to FIG. 2.

The selection signal SLA whose logic level is switched to either “0” or “1” at a 4 kHz frequency is applied to the first and second speed change circuit 14 and 22. In response to the level change of the selection signal SLA, the read-out from and the writing to the first and the second sending buffers 14a and 14b are switched in every 125 μs in the first speed change circuit 14. As well as the first speed change circuit 14, in response to the level change of the selection signal SLA, the read-out from and the writing to the first and the second receiving buffers 22a and 22b are switched in every 125 μs in the second speed change circuit 22. The selection of the buffers 14a and 14b in the first speed change circuit 14 and the selection of the buffers 22a and 22b in the second speed change circuit 22 are performed by the same selection signal SLA, that is, the selections in both circuit 14 and 22 are synchronized to each other.

The selection signal SLB with 8 kHz, which is synchronized with the selection signal SLA, is applied to the switch 17. In response to the selection signal SLB, the sending and the receiving are switched by the switch 17 in every 62.5 μs. The clock signal CLK with 128 kHz is continuously applied to the ΔΣ modulator 13 and the first and the second speed change circuits 14 and 22.

The audio input AI is transformed into the electric signal in the acoustic input device 11, then, is deducted its unnecessary high frequency component, such as higher than 4 kHz by the first LPF 12, and then is applied to a ΔΣ modulator 13.

The ΔΣ modulator 13 generates a pulse signal S13, which is a 1 bit digital variable density signal whose frequency of the level change is changed in response to the level change speed of the input signal. The pulse signal S13 is a continuing signal, and its bit speed corresponds to the clock signal CLK, that is, 128 kbps. As shown in FIG. 2, the greater the level change of the audio input AO is, the higher the occurrence frequency of the pulse signal S13 having the logic level “1” is. Thus, the smaller the level change of the audio input AO is, the lower the occurrence frequency of the pulse signal S13 having the logic level “1” is. The pulse signal S13 is also applied to the first speed change circuit 14 as a next stage. The ΔΣ modulator 13 is continuously operated regardless the time periods A˜D shown in FIG. 2.

During the time periods A and B, which is the time period that the selection signal SLA having “0” level is applied, the first sending buffer 14a is selected by the first selector 14c in the first speed change circuit 14. Thus, the continuing pulse signal S13 as the voice data for sending is continuously written in the first sending buffer 14a in a real time in response to the clock signal CLK. On the other hand, the first receiving buffer 22a is selected by the fourth selector 22d in the second speed change circuit 22. Thus, the voice data stored in the first receiving buffer 22a are continuously read out through the fourth selector 22d in a real time in response to the clock signal CLK, and are applied as the continuing pulse signal S22 to the second LPF 23. The second LPF 23 regenerates the receiving voice signal by deducting the unnecessary high frequency component of the continuing pulse signal S22. The acoustic output device 24 transforms the electric signal from the second LPF 23 into the audio output AO.

Since the second sending buffer 14b is selected by the second selector 14d in the first speed change circuit 14 during the time periods A and B, the second sending buffer 14b is electrically connected to the sending frame processing circuit 15 through the second selector 14d. Since the second receiving buffer 22b is selected by the third selector 22c in the second speed change circuit 22 during the time periods A and B, the second receiving buffer 22b is electrically connected to the receiving frame processing circuit 21 through the third selector 22c.

During the time period A, which is the time period that both of the selection signals SLA and SLB both having “0” level are applied, the voice data stored in the second sending buffer 14b are read-out at a burst and rapidly by the sending frame processing circuit 15 in response to the sending clock signal SCK. In the sending frame processing circuit 15, the sending data SDT supplied from the control circuit are added on the read-out voice data, and then, the sending frame is generated by further tacking a header HDR on its head. The sending frame is sent from the sending frame processing circuit 15 to the FSK modulator 16.

In accordance with the sending frame outputted from the sending frame processing circuit 15, the FSK modulator 16 FSK-modulates a frequency carrier FC. The output signal from the FSK modulator 16 is transmitted to the BPF 18 through the switch 17, and the frequency component other than the radio frequency bandwidth in use is removed in BPF 18, and then the filtered output signal from the FSK modulator 16 is sent from the antenna 19 as a packet high radio frequency signal RF.

During the time period B, which is the time period that the selection signal SLA having “0” level and the selection signal SLB having “1” are applied, the FSK demodulator 20 is selected by the switch 17. Thus, a packet high radio frequency signal RF, which is sent from the intended party and received at the antenna 19, is applied to the FSK demodulator 20 through the BPF 18 and the switch 17.

The packet high radio frequency signal RF of the FSK modulated frequency carrier FC is demodulated in the FSK demodulator 20, and the receiving clock signal RCK and the time-division frame (receiving frame) are regenerated, and sent to the receiving frame processing circuit 21. The receiving frame processing circuit 21 analyzes the receiving frame. As a result, the voice data sent from the intended party and the sending data from its own circuit are separated. The separated sending data are sent to the control circuit as a receiving data RDT, and the voice signal is written at a burst in the second receiving buffer 22b of the second speed change circuit 22 in response to the timing signal having 300 kHz.

During the time periods C and D, which is the time period that the selection signal SLA having “1” level is applied, the first selector 14c in the first speed change circuit 14 switches to the second sending suffer 14b from the first sending buffer 14a, and the fourth selector 22d in the second speed change circuit 22 switches to the second receiving suffer 22b from the first receiving buffer 22a. Thus, the voice data (the pulse signal S13) for sending, which are generated in the ΔΣ modulator 13, are written in the second sending buffer 14b in a real time in response to the clock signal CLK. On the other hand, the voice data for receiving stored in the second receiving buffer 22b are read in a real time in response to the clock signal CLK. During the periods, the second selector 14d in the first speed change circuit 14 switches to the first sending buffer 14a from the second sending buffer 14b, and the third selector 22c in the second speed change circuit 22 switches to the first receiving buffer 22a from the second receiving buffer 22b.

Further, during the period C designed as a sending period, the voice data stored in the first sending buffer 14c are read out at a burst and rapidly by the sending frame processing circuit 15, and the sending frame is generated. The sending frame is FSK modulated in the FSK modulator 16, and finally outputted from the antenna 18 as the packet high radio frequency signal RF.

Moreover, during the period D, a packet high radio frequency signal RF, which is sent from the intended party and received at the antenna 19, is demodulated in the FSK demodulator 20. Then, the voice data are separated from the receiving frame in the receiving frame processing circuit 21, and then, the separated voice data are written in the first receiving buffer 22a in the second speed change circuit 22.

By repeating the periods A˜D, the full duplex communication, which sends and receives voice data at the same time, can be performed.

According to the wireless voice communication circuit of the first embodiment of the invention, in order to perform the duplex communication, the voice signal is transformed into the one-bit digital data or the one-bit digital data are transformed into the voice signal, and, the one-bit digital data are digital-modulated or digital-demodulated and sent/received by using radio lines. Thus, the following advantages can be expected.
(1) Since the pulse signal S13, which is generated in the ΔΣ modulator 13, is modulated as a binary digital signal, and then, sent to the intended party, the CODEC, which compresses and encodes the voice signal, is not required. Thus, the increase of the scale and the cost of the circuit can be suppressed,
(2) Since no compressing and decoding are performed, the time delay by which the communication quality is influenced does not occur so that no echo canceller is required. Thus, the increase of the scale and the cost of the circuit further can be suppressed, and
(3) Since no compressing and decoding are performed, the wireless voice communication circuit of this invention does not have least influence of the deterioration of the communication quality caused by the transmittance error in the signal transmittance route.

### The Second Embodiment

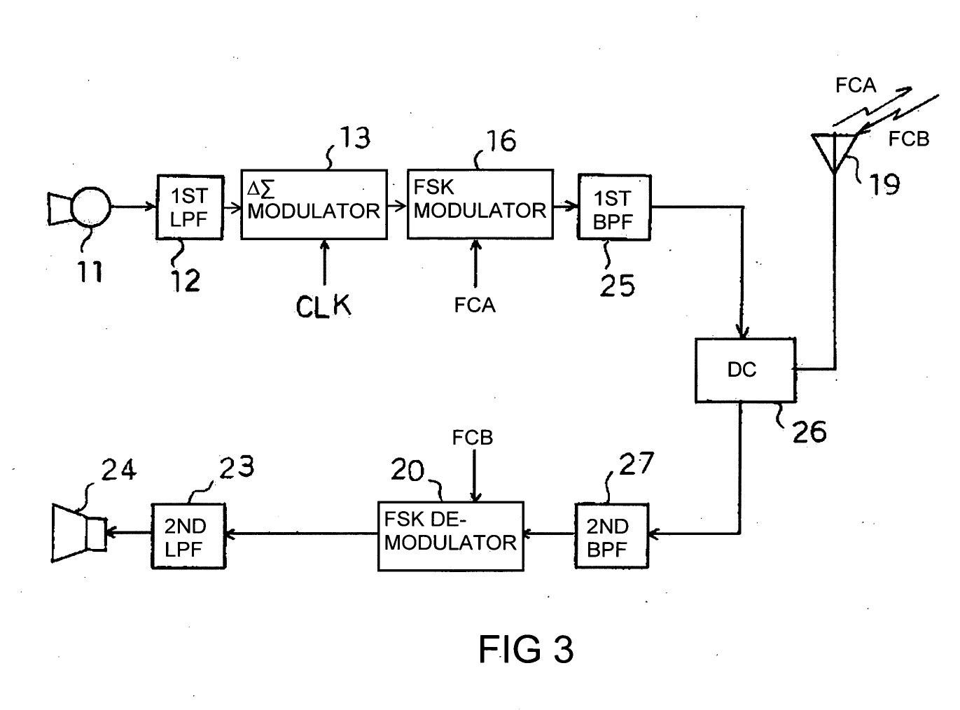

FIG. 3 is a circuit diagram of a wireless voice communication circuit, according to the second embodiment. In FIG. 3, the same reference numbers designate the same or similar components used in FIG. 1

The wireless voice communication circuit shown in FIG. 3 is a Frequency Division Duplex FDD type wireless voice communication circuit 300 for sending and receiving a digital voice signal by using a two different Frequency Carriers FCA and FCB.

The wireless voice communication circuit 200 includes an acoustic input device 11 for transforming an audio input Al into an electric signal, such as a microphone. The electric signal transformed in the acoustic input device 11 is applied to a delta sigma ΔΣ modulator 13 though a first Low Pass Filter (LPF) 12. A continuing pulse signal as a digital variable density signal outputted from the ΔΣ modulator 13 is applied to a Frequency Shift Keying FSK modulator 16.

In accordance with the pulse signal outputted from the ΔΣ modulator 13, the FSK modulator 16 FSK-modulates the first frequency carrier FCA. The output of the FSK modulator 16 is connected to a Directional Coupler DC 25 through a first Band Pass Filter BPF 25, which prevents the radiation of an unnecessary radio wave. The DC 25 outputs a high radio frequency signal supplied from the first BPF 25 to an antenna 19, and outputs a high radio frequency signal received at the antenna 19 to a second BPF 27.

The second BPF 27 extracts a signal of the second frequency carrier FCA, which is a radio frequency bandwidth in use, from the high radio frequency signal received at the antenna 19. The output of the second BPF 27 is connected to a FSK demodulator 20. The FSK demodulator 20 demodulates the FSK-modulated high frequency signal supplied from the BPF 27, regenerates a pulse signal sent from the intended party, and sends to a second LPF 23. The second LPF 23 regenerates the receiving voice signal by deducting the unnecessary high frequency component of the continuing pulse signal. The output of the second LPF 23 is connected to an acoustic output device 24. The acoustic output device 24 transforms the electric signal from the second LPF 23 into an audio output AO as an acoustic signal.

According to the wireless voice communication circuit of the second embodiment, the audio input Al is transformed into the electric signal at the acoustic input device 11, and then, the electric signal is transformed into the continuing pulse signal as the digital variable density signal at the ΔΣ modulator 13 after the unnecessary high frequency component is removed. The pulse signal generated in the ΔΣ modulator 13 is applied to the FSK modulator 16, and then, the first frequency carrier-FCA is modulated to the binary FSK signal in response to the pulse signal in the FSK modulator 16. After unnecessary frequency bandwidth of the FSK-modulated first frequency carrier FCA is removed at the BPF 25, the high frequency signal of the continuing frequency carrier FCA is continuously sent from the antenna 19 through the DC 26.

On the other hand, the high frequency signal received at the antenna 19 is applied to the second BPF 27 through the DC 26. The second BPF 27 extracts the desired high frequency signal of the second frequency carrier FCA, and sends it to the FSK demodulator 20. The FSK demodulator 20 demodulates the high frequency signal supplied from the BPF 27, regenerates a continuing pulse signal, and sends to the second LPF 23. The second LPF 23 regenerates the receiving voice signal by deducting the unnecessary high frequency component of the continuing pulse signal. The voice signal is applied to the acoustic output device 24, and the acoustic output device 24 transforms the voice signal from the second LPF 23 into an audio output AO as an acoustic signal.

According to the wireless voice communication circuit of the second embodiment of the invention, in order to perform the duplex communication, the voice signal can be sent and received as the continuing pulse signal by using the two different frequency carriers FCA and FCB, wherein one FCA is for sending; the other FCB is for receiving. Thus, as well as the first embodiment of the invention, neither the CORDE nor the echo canceller is required. Further, the first and the second speed change circuits 14 and 22 ant their control circuit, which are required in the first embodiment, are not required anymore so that the simplification of the circuit can be expected. However, data for the control cannot be sent and received under the circuit of the second embodiment. Thus, when the data for the control are intended to send or receive, a multiple separation circuit for such data needs to add on the circuit shown in FIG. 3.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views. Moreover, the numerical description in the embodiment described above is one of the preferred examples in the preferred embodiment so that the scope of the invention should not be construed to limit to them.

For example, (a) although each frequency of the clock signal CLK or the first and the second selection signals SLA and SLB is set to correspond to the frequency bandwidth (300˜3400 Hz) of the voice signal used in the regular telephone line, it can be changed in accordance with a desired voice communication quality, (b) the method of the modulation is not limited to the FSK, so a Phase Shift Keying PSK can be used, and (c) although the ΔΣ modulator 13 outputs the single bit continuing pulse signal S13, it is possible to use a ΔΣ modulator, which outputs binary continuing pulse signal.

Various other modifications of the illustrated embodiment will be apparent to those skilled in the art on reference to this description. Therefore, the appended claims are intended to cover any such modifications or embodiments as fall within the true scope of the invention.

What I claim is:

1. A wireless voice communication circuit, comprising:
an analog-digital converter generating a first digital signal whose frequency of the level change is changed in response to the level change speed of a sending audio signal, the first digital signal being a continuing binary signal;
a first speed change circuit writing the first digital signal temporally in a first buffer for compressing in a time-division frame, and reading out the signal stored in the first buffer at a burst in response to a read-out timing signal;
a sending frame processing circuit applying the read-out timing signal to the first speed change circuit at sending, and generating a sending frame, which includes the first digital signal read-out from the first speed change circuit;
a modulator digital-modulating a frequency carrier applied to the modulator in response to the sending frame, and sending it as a radio frequency signal to an intended party;
a demodulator demodulating a radio frequency signal sent from the intended party at receiving, and outputting a receiving frame;
a receiving frame processing circuit extracting a second digital signal whose frequency of the level change is changed in response to the level change speed of a receiving audio signal wherein the second digital signal is included in the radio frequency signal sent from the intended party, and outputting it together with a writing timing signal;
a second speed change circuit writing the second signal in a second buffer temporally in response to the writing timing signal, and reading out the signal stored in the second buffer at constant speed; and
a digital-analog converter generating a receiving voice signal by removing a high frequency component of the second digital signal read-out from the second speed change circuit.

2. A wireless voice communication circuit as claimed in claim 1, wherein the first digital signal is a one-bit signal.

3. A wireless voice communication circuit as claimed in claim 2, wherein the analog-digital converter includes a delta sigma modulator, the delta sigma modulator comprising an adder circuit, which deducts the first digital signal from the sending voice signal, an integration circuit, which integrates the output signal of the adder circuit, a comparator, which generates the first digital signal by comparing the output signal of the integration circuit with a threshold, and a delay circuit, which delays the first digital signal and feeds back the delayed first digital signal to the adder circuit.

4. A wireless voice communication circuit as claimed in claim 1, wherein each of the first and the second speed change circuits includes an additional buffer, and wherein a selection between the buffer and the additional buffer in the first speed change circuit and a selection between the buffer and the additional buffer in the second speed change circuit are made by a same selection signal.

5. A wireless voice communication circuit as claimed in claim 1, wherein the first digital signal is a two-bit signal,

6. A wireless voice communication circuit as claimed in claim 1, wherein the modulator is a frequency shift keying modulator.

7. A wireless voice communication circuit as claimed in claim 1, wherein the modulator is a phase shift keying modulator.

8. A wireless voice communication circuit, comprising:
an analog-digital converter generating a first digital signal whose frequency of the level change is changed in response to the level change speed of a sending audio signal, the first digital signal being a continuing binary signal;
a modulator digital-modulating a first frequency carrier applied to the modulator in response to the first digital signal, and sending it to an intended party;
a demodulator demodulating a second frequency carrier sent from the intended party, and outputting a second digital signal whose frequency of the level change is changed in response to the level change speed of a receiving audio signal; and
a digital-analog converter generating a receiving voice signal by removing a high frequency component of the second digital signal.

9. A wireless voice communication circuit as claimed in claim 1, further comprising a multiple separation circuit for sending and receiving control data.
